(19) United States
(12) Patent Application Publication
(10) Pub. No.: US 2019/0007531 A1
(43) Pub. Date: Jan. 3, 2019

(54) ELECTRONIC DEVICE

(71) Applicants: Yi-Min Wang, Taipei City (TW); Shih-Hai Yu, Taipei City (TW); Chun-Hsin Wu, Taipei City (TW); Hung-Ching Huang, Taipei City (TW)

(72) Inventors: Yi-Min Wang, Taipei City (TW); Shih-Hai Yu, Taipei City (TW); Chun-Hsin Wu, Taipei City (TW); Hung-Ching Huang, Taipei City (TW)

(73) Assignee: COMPAL ELECTRONICS, INC., Taipei City (TW)

(21) Appl. No.: 15/675,804

(22) Filed: Aug. 14, 2017

(30) Foreign Application Priority Data
Jul. 3, 2017 (TW) 106122183

(51) Int. Cl. H04M 1/02; G04G 21/08; G04G 9/00; G04G 21/04; G04R 60/10; H04B 1/3827; G04B 37/14; G04G 17/08

(52) U.S. Cl. CPC H04M 1/02; G04G 21/08; G04G 9/0064; G04G 21/04; H04M 1/72558; H04B 1/385; G04B 37/1486; G04G 17/08; G04R 60/10

(57) ABSTRACT

An electronic device including a casing, a printed circuit board, a contact spring and a connector is provided. The printed circuit board is disposed in the casing, and the contact spring is electrically connected to and located on the printed circuit board. The connector is movably disposed at the casing, and a part of the connector is protruded from the casing. While the connector is pressed by external force, the connector is moved to contact the contact spring so as to conduct with the printed circuit board.

### CROSS-REFERENCE TO RELATED APPLICATION

This application claims the priority benefit of Taiwan application serial no. 106122183, filed on Jul. 3, 2017. The entirety of the above-mentioned patent application is hereby incorporated by reference herein and made a part of this specification.

### BACKGROUND OF THE INVENTION

### Field of the Invention

The invention is related to an electronic device, and particularly to an electronic device having a longer service life.

### Description of Related Art

Currently, the development of electronic devices (e.g., wear device) advances rapidly. The application of smart bracelets, watches, head-mounted display devices, wear clothing technology and so on is getting broader and broader; they are not only applied to medical and entertainment fields, but also employed in daily life and sports. In existing electronic device and its corresponding external device (e.g., a charger), if a contact-type charger or transmitting connector is adopted, it would be a combination of conductive pillar and a pogopin in general. Specifically, the connector of the charger includes, for example, a pogopin, and the connector of the electronic device, for example, includes a conductive pillar. The conductive pillar of the electronic device is electrically connected to the circuit board in the electronic device. Accordingly, when the pogopin of the charger contacts the conductive pillar of the electronic device, the electronic device is charged.

However, since the conductive pillar of the electronic device is conducted with the circuit board, the conductive pillar is easily affected by moisture from the environment and user's sweat and thus rusted due to an electrolyzing effect. Moreover, since the conductive pillar of the electronic device is conducted with the circuit board, the impurity in the moisture is easily attached to the surface of the conductive pillar, affecting the conducting effect of the conductive pillar, thus reducing the service life of the electronic device.

### SUMMARY OF THE INVENTION

The invention provides an electronic device, of which a connector is not conducted with a circuit board in a non-charging state or non-transmitting state so as to reduce occurrence of an electrolyzing effect, thereby prolonging the service life of the electronic device.

An electronic device of the invention includes a casing, a circuit board disposed within the casing, a contact spring disposed on the circuit board and conducted with the same and a connector. The connector is movably disposed on the casing and partially protruded from the casing. When the connector is pressed by an external force, the connector is moved to contact the contact spring so as to be conducted with the circuit board.

In one embodiment of the invention, the connector includes a holder and a moving element passing through the holder. The holder fixed on the casing of the electronic device further includes a through-hole. The moving element includes a conductive pillar and an expanding portion. An aperture of the through-hole is larger than a diameter of the conductive pillar and smaller than the size of the expanding portion.

In one embodiment of the invention, the connector further includes an elastic element sleeved on the conductive pillar and located between the holder and the expanding portion.

In one embodiment of the invention, the connector further includes a first water-proof ring sleeved on the conductive pillar and located between the holder and the elastic element.

In one embodiment of the invention, the connector further includes a washer sleeved on the conductive pillar and located between the first water-proof ring and the elastic element.

In one embodiment of the invention, the conductive pillar includes a contact end away from the expanding portion and a neck portion close to the contact end. The contact end is adapted to contact the contact spring. The connector further includes a stopping element having a size larger than the through-hole and sleeved on the neck portion. The stopping element and the expanding portion are respectively located on two sides of the through-hole.

In one embodiment of the invention, the holder and the expanding portion are respectively formed as two cup-shaped structures with openings facing each other.

In one embodiment of the invention, the casing includes a connector accommodating recess, which is divided into a first portion and a second portion along a moving direction of the connector; the connector is disposed in the connector accommodating recess. The width of the first portion is larger than the width of the second portion; the expanding portion is disposed in the first portion, and the holder is fixed to the second portion.

In one embodiment of the invention, the connector further includes a second water-proof ring disposed between an inner wall surface of the second portion of the connector accommodating recess and the holder.

In one embodiment of the invention, the holder is fastened to the inner wall surface of the second portion of the connector accommodating recess.

In one embodiment of the invention, the electronic device is a wear device.

In summary, in the electronic device of the invention, the connector is movably disposed on the casing; in normal state, the connector is not in contact with the contact spring and thus maintains to be electrically isolated from the circuit board. When the connector of the electronic device is subjected to an external force, for example, when the connector of an external device is docked to the connector of the electronic device, the connector of the electronic device is moved relative to the casing and brought into contact with the contact spring to be conducted with the circuit board. With such configuration, the connector of the electronic device of the invention is conducted with the circuit board only when transmission is carried out, so as to reduce the occurrence of the electrolyzing effect due to high-humidity environment, thereby prolonging the service life of electronic device.

In order to make the aforementioned features and advantages of the invention more comprehensible, embodiments accompanying figures are described in detail below.

### BRIEF DESCRIPTION OF THE DRAWINGS

FIG. 1 is a three-dimensional schematic view of an electronic device and an external device before being docked to each other according one embodiment of the invention.

FIG. 2 is a schematic view of a rear surface of the electronic device of FIG. 1.

FIG. 3 is a partial cross-sectional view of the electronic device of FIG. 1 along a plane P of FIG. 1.

FIGS. 4A and 4B are respectively partial enlargement views of FIG. 3.

FIG. 5 is an explosive view of a connector of the electronic device of FIG. 1.

FIG. 6 is a partial cross-sectional view of the electronic device of FIG. 1 docked with a charger.

FIG. 7 is a partial enlargement view of FIG. 6.

FIG. 8 is a cross-sectional view of an electronic device according to another embodiment of the invention.

### DESCRIPTION OF EMBODIMENTS

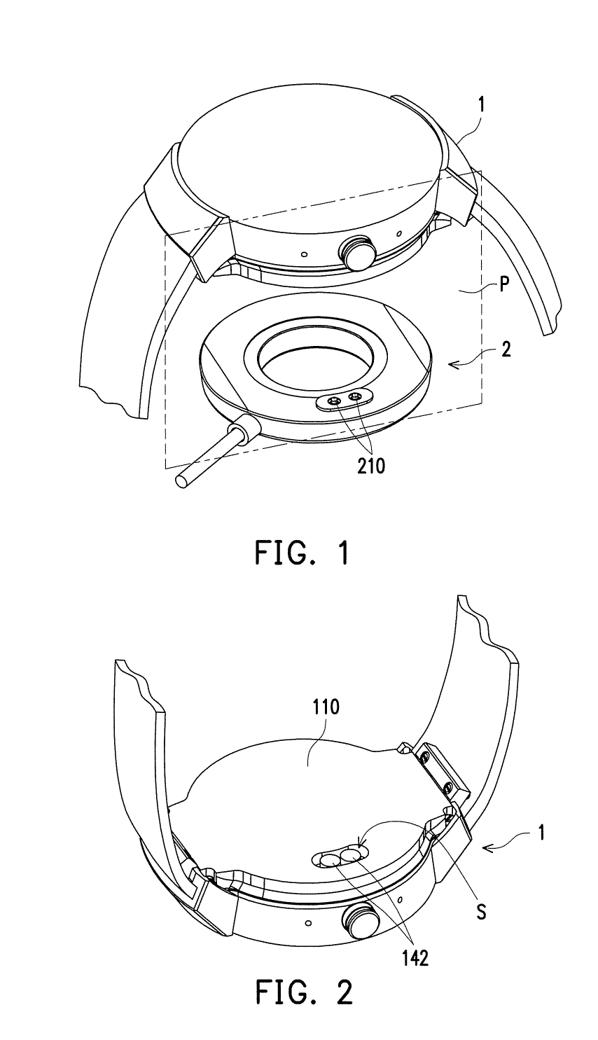

FIG. 1 is a three-dimensional schematic view of an electronic device and an external device before being docked to each other according one embodiment of the invention. FIG. 2 is a schematic view of a rear surface of the electronic device of FIG. 1. Referring to FIGS. 1 and 2, in the embodiment, an electronic device 1 is exemplified as a wear device, such as a smart watch. An external device 2 is exemplified as a charger. The electronic device 1 is adapted to be docked to the external device 2 for charging. Certainly, in other embodiments, the electronic device 1 may be other electronic devices such as a smart bracelet, a head-mounting display device or wear clothing. The external device 2 may be other devices such as a computer or a docking station. The electronic device 1 may be docked to the external device 2 to carry out data transmission. The invention provides no limitation to the types and connection purpose of the electronic device 1 and the external device 2.

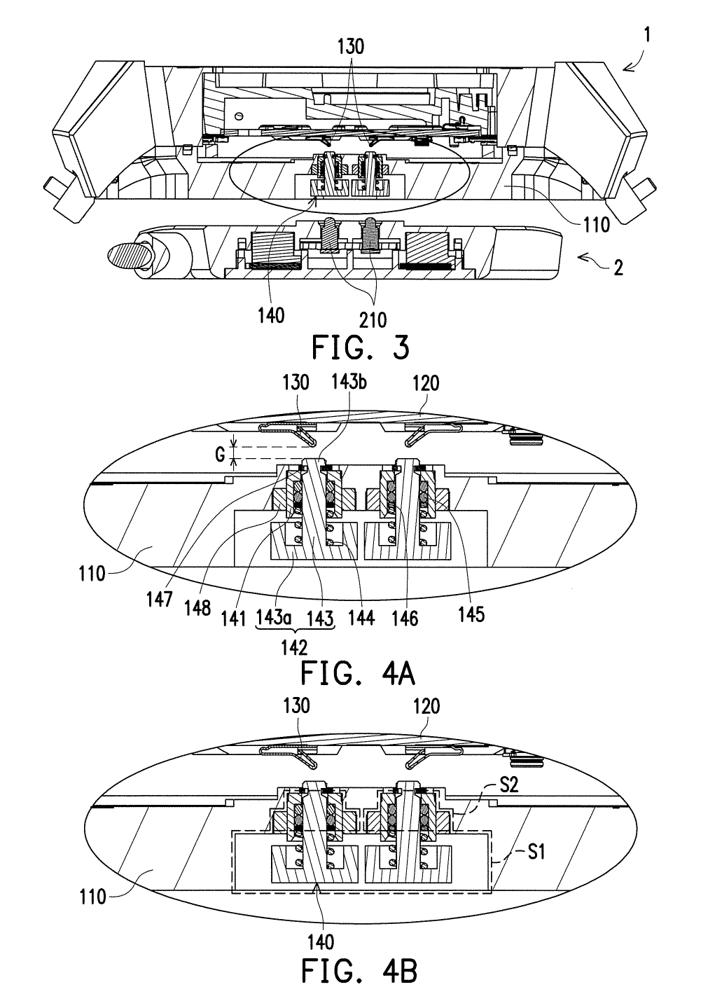

FIG. 3 is a partial cross-sectional view of the electronic device of FIG. 1 along a plane P of FIG. 1. FIGS. 4A and 4B are respectively partial enlargement views of FIG. 3. The plane P illustrated in FIG. 1 passes through a connector 140 of the electronic device 1 and a pogopin 210 of the external device 2 so as to clearly show the relationship between the two via the cross-sectional view of FIG. 3. Referring to FIGS. 1 to 4B at the same time, the electronic device 1 of the embodiment includes a casing 110, a circuit board 120 disposed within the casing 110, a contact spring 130 disposed on the circuit board 120 and conducted with the same, and a connector 140 (shown in FIG. 3) movably disposed on the casing 110. The casing 110 of the electronic device 1 of the embodiment includes a connector accommodating recess S (see FIG. 2), and the connector 140 is disposed in the connector accommodating recess S. A portion of the connector 140 is protruded from a bottom surface of the connector accommodating recess S of the casing 110.

As shown in FIG. 3, currently, the electronic device 1 and the external device 2 are not docked yet. In other words, the pogopin 210 of the external device 2 is not in contact with the connector 140 of the electronic device 1 yet. In addition, as shown in FIGS. 3 to 4B, when the electronic device 1 is not docked to the external device 2 yet, in the embodiment, the connector 140 of the electronic device 1 is not in contact with the contact spring 130 in the casing 110 either, and kept apart from the contact spring 130 by a gap G. Therefore, when the electronic device 1 is not docked to the external device 2 yet, the connector 140 of the electronic device 1 is electrically isolated from the circuit board 120. Thus, even if in a high-humidity environment, the connector 140 is not easily rusted due to an electrolyzing effect, and the impurity in the moisture is not easily attached to the surface of the connector 140, thus affecting the conductive effect of the connector 140.

Certainly, in the embodiment, when the connector 140 is pressed by an external force, the connector 140 is moved and brought into contact with the contact spring 130 to be conducted with the circuit board 120. For example, when the electronic device 1 is docked to the external device 2, the connector 140 is conducted with the circuit board 120 to carry out electrical transmission. The following paragraph describes the structure of the connector 140 in details first for ease of subsequent description regarding how the connector 140 is conducted with the circuit board 120 when being docked to the external device 2.

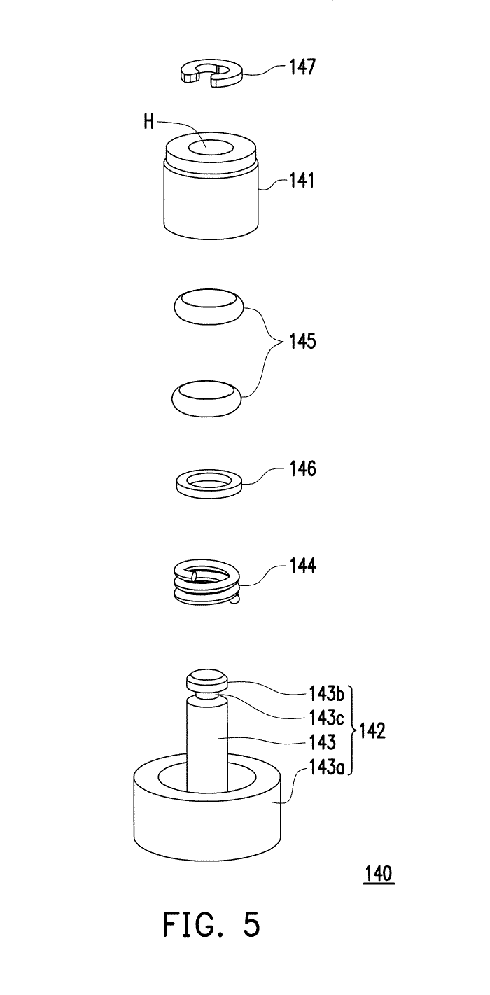

FIG. 5 is an explosive view of a connector of the electronic device of FIG. 1. Referring to FIGS. 4A and 5, the connector 140 includes a holder 141, a moving element 142, an elastic element 144, at least one first water-proof ring 145, a washer 146 and a stopping element 147. The holder 141 is fixed to the casing 110 and includes a through-hole H. The moving element 142 includes a conductive pillar 143 and an expanding portion 143a connected to one end of the conductive pillar 143. The conductive pillar 143 includes a contact end 143b away from the expanding portion 143a and adapted to contact the contact spring 130 as well as a neck portion 143c close to the contact end 143b. The contact end 143b and the expanding portion 143a are respectively disposed on two opposite ends of the conductive pillar 143. In the embodiment, the material of the conductive pillar 143 and the expanding portion 143a may be metal, and the conductive pillar 143 and the expanding portion 143a may be formed in an integrated manner. However, the invention provides no limitation to the material and fabrication method of the conductive pillar 143 and the expanding portion 143a.

In the embodiment, the elastic element 144 is sleeved on the conductive pillar 143 and located between the holder 141 and expanding portion 143a for maintaining or restoring the distance between the holder 141 and the expanding portion 143a when the connector 140 is not pressed (normal state). In the embodiment, the elastic element 144 is exemplified as a spring. However, in other embodiments, the elastic element 144 may be other element that can provide a restoring force, and the invention provides no limitation to the type of the elastic element 144.

The first water-proof ring 145 is sleeved on the conductive pillar 143 and located between the holder 141 and the elastic element 144. In this manner, even if the conductive pillar 143 can move relative to the holder 141, the first water-proof ring 145 can prevent liquid from permeating into the casing 110 from the seam between the conductive pillar 143 and the holder 141 so as to achieve the water-proof effect. In the embodiment, the number of the first water-proof ring 145 is two for exemplary purpose; the first water-proof ring 145 may be a rubber O-ring or a silicone O-ring. However, the invention provides no limitation to the number and type of the first water-proof ring 145. The washer 146 is sleeved on the conductive pillar 143 and located between the first water-proof ring 145 and the elastic element 144 so as to reduce friction generated between the water-proof ring 145 and the elastic element 144. In other embodiments, the configuration of the washer 146 may be omitted.

In the embodiment, the holder 141 and the expanding portion 143a are respectively formed as two cup-shaped structures with openings facing each other. The elastic element 144, the first water-proof ring 145 and the washer 146 are disposed between the two-cup shaped structures. The design of cup-shaped structure can prevent the elastic element 144, the first water-proof ring 145 and the washer 146 from being easily detached between the holder 141 and the expanding portion 143a.

Additionally, in the embodiment, an aperture of the through-hole H of the holder 141 is larger than a diameter of the conductive pillar 143 and smaller than the size of the expanding portion 143a. A contact end 143b of the conductive pillar 143 may pass through the through-hole H toward the direction of the contact spring 130. The stopping element 147 is sleeved on the neck portion 143c. The stopping element 147 may be a C-shaped ring, but the invention provides no limitation to the type of the stopping element 147. The stopping element 147 and the expanding portion 143a are respectively disposed on two sides of the holder 141. An outer diameter of the stopping element 147 is larger than the size of the through-hole H, and thus the contact end 143b of the conductive pillar 143 maintains to stay outside of the holder 141, thereby avoiding the moving element 142 from moving downward and being detached from the holder 141.

Referring to FIG. 4B again, in the embodiment, the connector accommodating recess S of the casing 110 of the electronic device 1 includes a first portion S1 and a second portion S2 along a moving direction (i.e., the vertical direction of the drawing) of the connector 140. The width of the first portion S1 is larger than the width of the second portion S2; the expanding portion 143a (illustrated in FIG. 4A) is disposed in the first portion S1; and the holder 141 (illustrated in FIG. 4A) is fixed to the second portion S2 of the connector accommodating recess S.

In the embodiment, since the expanding portion 143a of the conductive pillar 143 can accommodate the first portion S1 without protruding from the casing 110, thereby avoiding the user from touching the expanding portion 143a by mistake. Certainly, in the embodiment, the expanding portion 143a may be protruded from the first portion S1, and the relative position between the expanding portion 143a and the casing 110 is not limited thereto.

It should be indicated that, in order to prevent sweat or liquid from entering the casing 110 via the connector accommodating recess S of the casing 110, thus causing the circuit board 120 to get wet or damaged, in the embodiment, the connector 140 further includes a second water-proof ring 148 disposed between an inner wall surface of the second portion S2 of the connector accommodating recess S and the holder 141 so as to avoid the liquid from permeating into the casing 110 from the gap between the inner wall surface of the second portion S2 of the connector accommodating recess S and the holder 141. In the embodiment, the second water-proof ring 148 may be a rubber O-ring or a silicone O-ring, but the invention provides no limitation to the type of the second water-proof ring 148. Test results show that the electronic device 1 of the embodiment can achieve a water-proof effect at the IPX8 level.

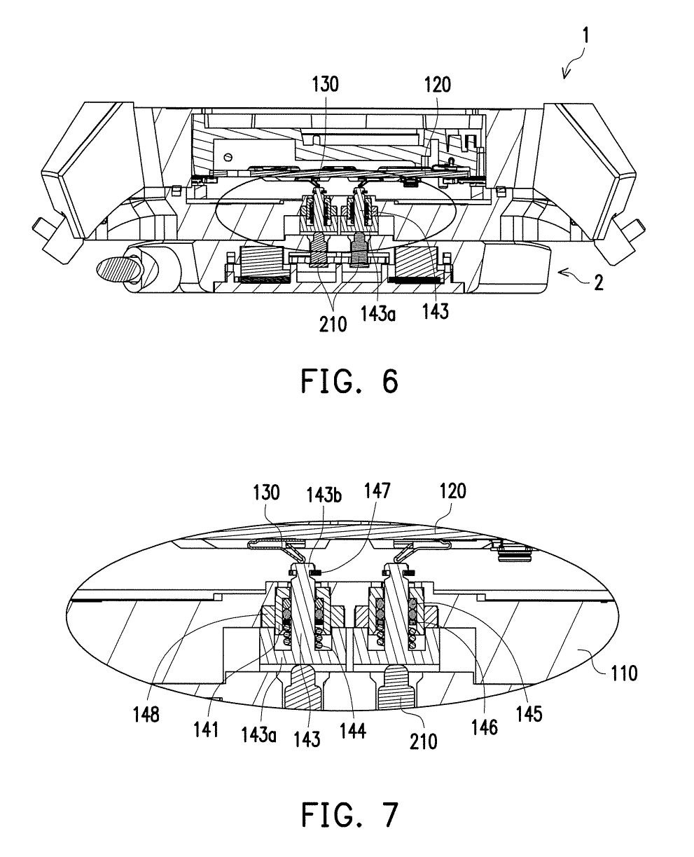

FIG. 6 is a partial cross-sectional view of the electronic device of FIG. 1 docked to a charger. FIG. 7 is a partial enlargement view of FIG. 6. Referring to FIGS. 6 and 7, when the connector 140 of the electronic device 1 is docked to the pogopin 210 of the external device 2, the pogopin 210 of the external device 2 pushes against the expanding portion 143a of the electronic device 1, such that the conductive pillar 143 is moved upward relative to the casing 110 and the holder 141, and the contact end 143b of the conductive pillar 143 contacts the contact spring 130 to be electrically connected to the circuit board 120. In other words, at this time, the pogopin 210 of the external device 2 can be electrically connected to the circuit board 120 via the connector 140 and the contact spring 130.

When the electronic device 1 leaves the external device 2, the elastic element 144 releases an elastic potential energy accumulated during being pushed so as for the moving element 142 of the connector to return to the original position. The contact end 143b of the conductive pillar 143 is separated from the contact spring 130 again, and the connector 140 returns to the position as shown in FIG. 3 without being conducted with the circuit board 120.

In the embodiment, the electronic device 1 is designed to be movably disposed on the casing 110 via the moving element 142 of the connector 140. In normal state, the contact end 143b of the conductive pillar 143 is not in contact with the contact spring 130 to maintain electrically isolated from the circuit board 120. When the pogopin 210 of the external device 2 is docked to the connector 140 of the electronic device 1, the connector 140 of the electronic device 1 is moved relative to the casing 110 to contact the contact spring 130 so as to be conducted with the circuit board 120. In this manner, the connector 140 of the electronic device 1 is conducted with the circuit board 120 only when transmission is carried out, thereby reducing occurrence of the electrolyzing effect generated by the connector 140 due to high-humidity environment so as to prolong the service life of the electronic device 1.

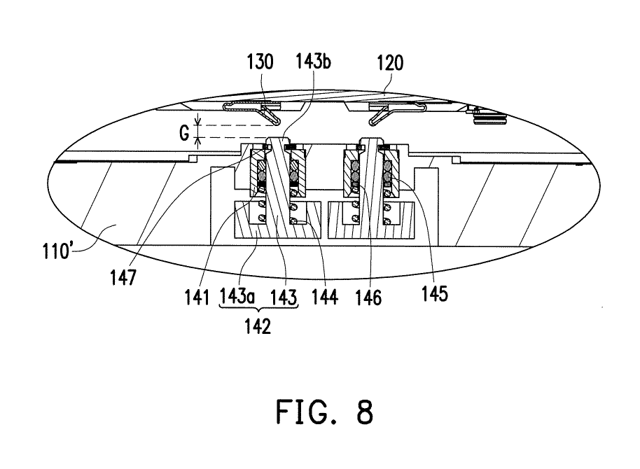

FIG. 8 is a cross-sectional view of an electronic device according to another embodiment of the invention. It should be indicated that, in the embodiment, the elements that are identical or similar to those mentioned in the previous embodiments are denoted by the same or similar reference numerals, and no further explanation is incorporated herein. The following embodiment mainly describes major differences. Referring to FIG. 8, the major difference between an electronic device of FIG. 8 and the electronic device 1 of the previous embodiment is that, in the previous embodiment, FIG. 4A shows that the second water-proof ring 148 is disposed between the holder 141 and the adjacent casing 110 so as to achieve the water-proof effect. In the embodiment, it is particularly designed that a casing 110′ is fastened to the holder 141 in a position corresponding to the holder 141 so as to omit the configuration of the second water-proof ring 148. Test results show that such configuration can also achieve the water-proof effect at the IPX8 level, thereby preventing moisture from entering the inside of the casing 110′ and thus causing damage.

In summary, in the electronic device of the invention, the connector is exposed and movably disposed on the casing. In normal state, the connector is not in contact with the contact spring and maintains electrically isolated from the circuit board. When the connector of the external device is docked to the connector of the electronic device, the connector of the electronic device is moved relative to the casing and brought into contact with the contact spring to be conducted with the circuit board. In this manner, the connector of the electronic device of the invention is conducted with the circuit board only when transmission is caffied out, thereby reducing the occurrence of electrolyzing effect due to high-humidity environment to prolong the life of the electronic device.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. An electronic device, comprising:
a casing;
a circuit board, disposed within the casing;
a contact spring, disposed on the circuit board and conducted with the circuit board; and
a connector, movably disposed on the casing and partially protruded from the casing,
wherein, when the connector is pressed by an external force, the connector is moved and brought into contact with the contact spring so as to be conducted with the circuit board.

2. The electronic device according to claim 1, wherein the connector comprises a holder and a moving element passing through the holder, the holder is fixed to the casing and comprises a through-hole, the moving element comprises a conductive pillar and an expanding portion connected to an end of the conductive pillar, an aperture of the through-hole is larger than a diameter of the conductive pillar and smaller than a size of the expanding portion.

3. The electronic device according to claim 2, wherein the connector further comprises an elastic element sleeved on the conductive pillar and disposed between the holder and the expanding portion.

4. The electronic device according to claim 3, wherein the connector further comprises a first water-proof ring, sleeved on the conductive pillar and disposed between the holder and the elastic element.

5. The electronic device according to claim 4, wherein the connector further comprises a washer, the washer is sleeved on the conductive pillar and disposed between the first water-proof ring and the elastic element.

6. The electronic device according to claim 2, wherein the conductive pillar comprises a contact end and a neck portion close to the contact end, the contact end is away from the expanding portion and is adapted to contact the contact spring, the connector further comprises a stopping element sleeved on the neck portion, a size of the stopping element is larger than a size of the through-hole, and the stopping element and the expanding portion are respectively disposed on two sides of the through-hole.

7. The electronic device according to claim 2, wherein the holder and the expanding portion are respectively formed as two cup-shaped structures with openings facing each other.

8. The electronic device according to claim 2, wherein the casing comprises a connector accommodating recess, the connector is disposed within the connector accommodating recess, the connector accommodating recess comprises a first portion and a second portion along a moving direction of the connector, a width of the first portion is larger than a width of the second portion, the expanding portion is located in the first portion, and the holder is fixed to the second portion.

9. The electronic device according to claim 8, wherein the connector further comprises a second water-proof ring, disposed between an inner wall surface of the second portion of the connector accommodating recess and the holder.

10. The electronic device according to claim 8, wherein the holder is fastened to an inner wall surface of the second portion of the connector accommodating recess.

11. The electronic device according to claim 1, wherein the electronic device is a wear device.
